(19) United States
(12) Patent Application Publication
(10) Pub. No.: US 2013/0229349 A1
(43) Pub. Date: Sep. 5, 2013

(54) OPTICAL TOUCH INPUT BY GESTURE DETECTION FROM VARYING IMAGES

(71) Applicant: PIXART IMAGING INC., Hsin-Chu City (TW)

(72) Inventors: Hsin-Chia CHEN, Hsin-Chu City (TW); Feng-Cheng YANG, Hsin-Chu City (TW); Ching-Lin CHUNG, Hsin-Chu City (TW); Wei-Yen KU, Hsin-Chu City (TW); Ming-Tsan KAO, Hsin-Chu City (TW)

(73) Assignee: PIXART IMAGING INC., Hsin-Chu City (TW)

(21) Appl. No.: 13/777,407

(22) Filed: Feb. 26, 2013

(30) Foreign Application Priority Data
Mar. 2, 2012 (TW) 101107101

(51) Int. Cl. G06F 3/042

(52) U.S. Cl. CPC G06F 3/0425
USPC 345/166; 345/173

(57) ABSTRACT

Optical imaging is used for touch input to implement device and method for gesture detection for better durableness, high resolution, simplifier structure, higher reliability, less power consumption, and faster response. A touch surface is provided for gesture operation thereon, and under light projecting to the touch surface, images are captured by receiving light from the touch surface. The varying images are monitored to detect if any gesture operates on the touch surface, and if a predefined gesture is detected, a gesture signal is generated.

### FIELD OF THE INVENTION

The present invention is generally related to a device and a method for input detection and, more particularly, to an optical touch device and an optical touch method.

### BACKGROUND OF THE INVENTION

Touch input has been extensively applied and further developed into gesture input applications. For example, U.S. Pat. No. 7,966,578 provides a method for multi-touch gesture detection, which not only simplifies an input device but also allows intuitional input operation. Conventionally, however, gesture detection is carried out by using a resistive or capacitive touch pad or touch panel, and thus has some unconquerable problems. The resistive touch panel uses a flexible film to receive pressing of a stylus for generating deformation to identify a touch point, and thus is less durable, has poor location resolution, and is hard to implement multi-touch applications. The capacitive touch pad and touch panel are stronger, but their location resolution depends on trace density. Thus, the location resolution is inherently limited by the width of each trace itself and the pitch between adjacent traces, and can only be improved by an algorithm of a post-end circuit. Moreover, the large number of interconnections between the traces and the microcontroller chip adds difficulty in performing wire layout on a printed circuit board. Further, since the microcontroller chip has so many pins to be bonded to the traces, it is hard to be downsized, and the numerous bonding points thereof can also reduce the reliability. Additionally, the capacitance detection of one trace requires charging and discharge one or more traces, and thus consumes considerable power and takes a long time. For either a resistive touch panel or a capacitive touch pad or touch panel, input detection includes scanning all its sensors for completing a frame of raw data and thus requires high-speed scanning and high-speed calculation, and even with a high-speed hardware, the time for obtaining one frame of data is still relatively long, which makes the frame rate hard to be increased and the response to input operation slower.

### SUMMARY OF THE INVENTION

An objective of the present invention is to provide an optical touch device and a method for input detection of an optical touch device.

Another objective of the present invention is to provide a device and a method for optical touch input by gesture detection.

A further objective of the present invention is to provide an input device and an input method that integrate gesture detection with a mouse function.

According to the present invention, an optical touch device includes a touch surface, a light source and an image sensor unit configured such that the light source provides light to project to the touch surface and the image sensor unit captures images by receiving light from the touch surface. The captured images are sent to a processing unit to identify if any gesture operates on the touch surface and to generate a corresponding gesture signal if a gesture is identified.

According to the present invention, a method for input detection includes providing light to project to a touch surface, capturing images by receiving light from the touch surface, identifying the captured images to detect if any gesture operates on the touch surface, and generating a corresponding gesture signal if a gesture is detected.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is a system block diagram of a first embodiment according to the present invention;

FIG. 2 is a hardware arrangement of the optical touch device shown in FIG. 1 when it is applied to a mouse;

FIG. 3 is a system block diagram of a second embodiment according to the present invention;

FIG. 4 is a hardware arrangement of the optical touch device shown in FIG. 3 when it is applied to a mouse; and

FIG. 5 shows images of various gestures detected by an optical touch device according to the present invention.

### DETAILED DESCRIPTION OF THE INVENTION

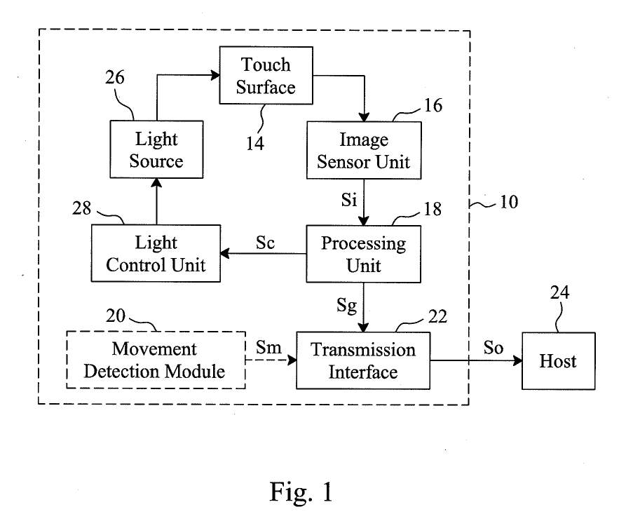

FIG. 1 is a system block diagram of a first embodiment according to the present invention, in which an optical touch device 10 includes a touch surface 14 to receive gesture operation thereon, a light source 26 arranged to be optically coupled to the touch surface 14 such that it can provide light to project to the touch surface 14, an image sensor unit 16 arranged to be optically coupled to the touch surface 14 such that it can capture images by receiving light from the touch surface 14 and generates an input signal Si to carry the captured images, and a processing unit 18 electrically coupled to the image sensor unit 16 to receive the input signal Si, to identify the images carried by the input signal Si to detect if any gesture operates on the touch surface 14, and to generate a corresponding gesture signal Sg if a gesture is detected. When a finger touches the touch surface 14, it will reflect light at the touch point, so that a light spot will appear in the image captured by the image sensor unit 16. According to the number and the locations of light spots in an image, the processing unit 18 can identify the number and the locations of fingers on the touch surface 14. From the varying images, the processing unit 18 can further identify change of the finger number and the moving direction of each finger to detect if any gesture operates on the touch surface 14. As is well known, the image sensor unit 16 includes an optical sensor, such as a CMOS image sensor (CIS) and a charge coupled device (CCD), to convert the received light into electronic signals, and may further include a lens or a pinhole for imaging on the optical sensor. Preferably, the image sensor unit 16 operates with one or more frame rates to generate images in a unit of frame, thus the input signal Si will contain image contents in a manner of frame by frame in a time sequence, and then the processing unit 18 can compare the image contents in two or more successive frames to identify variation of the images. The processing unit 18 can further calculate the moving speed of a finger with the frame rate of the image sensor unit 16 and the detected displacement of the finger. Since the processing unit 18 can identify different gestures from the input signal Si, it can generate various gesture signals Sg corresponding to the detected gestures.

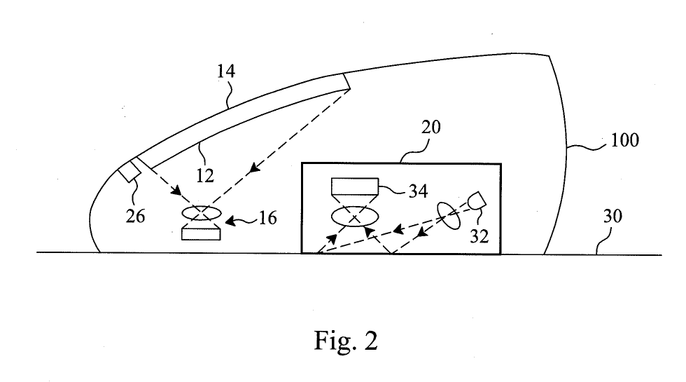

The optical touch device 10 may further integrate a mouse function. For example, as shown in FIG. 1, a movement detection module 20 includes a core established by a rolling-ball mechanism, an optical sensor, a motion sensor or a gyroscope, to detect the movement of the optical touch device 10 for generating a movement signal Sm, and a transmission interface 22 receives and then convert the gesture signal Sg and the movement signal Sm into an output signal So, for example by encoding under a communication protocol, to send to a host 24. Thus, the host 24 can control a cursor according to the movement signal Sm, and execute a command corresponding to the gesture signal Sg. A such integrated device may have a hardware arrangement as shown in FIG. 2. In a mouse housing 100, the movement detection module 20 is mounted at the bottom of the mouse housing 100 such that when the mouse housing 100 is placed on an operational plane 30, the movement detection module 20 is close to the operational plane 30, and similarly to a typical optical mouse, the movement detection module 20 includes a light source 32 to provide light to project to the operational plane 30 through a lens and then reflected by the operational plane 30 to impart on an image sensor 34 through another lens, the image sensor 34 keeps its image capturing, and a processing unit (not shown in the figure) generates a movement signal Sm according to the varying images. In this embodiment, the touch surface 14 is on the upper surface of a light guide plate 12 mounted in a front part of the top of the mouse housing 100, taking the place traditionally occupied by buttons and wheels of a conventional mouse, the light source 26 is fixed to a lateral of the light guide plate 12 and provides light of a specific wavelength, for example infrared ray, to project to the light guide plate 12, and the provided light penetrating into the light guide plate 12 propagates within the light guide plate 12 by internal total reflection and has a portion scattered by the light guide plate 12 to penetrate through the touch surface 14 outward. If a finger touches the touch surface 14, the finger will establish a reflective surface at the touch point to reflect light back into the mouse housing 100 and thus imparting on the image sensor unit 16. In another embodiment, the light guide plate 12 only allows invisible light, such as infrared ray, to pass therethrough, thereby preventing interference caused by ambient visible light. In the embodiment shown in FIG. 2, by detecting the gesture operating on the touch surface 14, the optical touch device can generate not only button signals and wheel signals as a normal mouse, but also many control signals that can not be generated by a normal mouse.

Preferably, referring back to FIG. 1, in addition to the light source 26, the optical touch device 10 further includes a light control unit 28 to control the light source 26. For example, the light control unit 28 may turn off the light source 26 in shutdown or standby, or may maintain the light source 26 at a small mute current in standby, or may only turn on the light source 26 when the image sensor unit 16 is going to capture images. Additionally, the processing unit 18 may identify brightness of one or more images from the input signal Si and generate a control signal Sc accordingly, for the light control unit 28 to adjust light intensity of the light source 26 to optimize the clarity of the captured images by the image sensor unit 16. Preferably, the processing unit 18 controls the light source 26 to be blinking fast during image capturing, so that the image sensor unit 16 will capture images when the light source 26 emits light and when the light source 26 does not emit light, respectively. Then, the difference between the images captured when the light source 26 emits light and when the light source 26 does not emit light can be used to eliminate the background value caused by ambient light. Since the image taken by the image sensor unit 16 when the light source 26 is off is the background value caused by ambient light, the interference from ambient light can be reduced by eliminating this background value. In other embodiments, it may switch the light projecting to the touch surface 14 by other means, for example using a shutter, such that the image sensor unit 16 can capture images when the light is on and off.

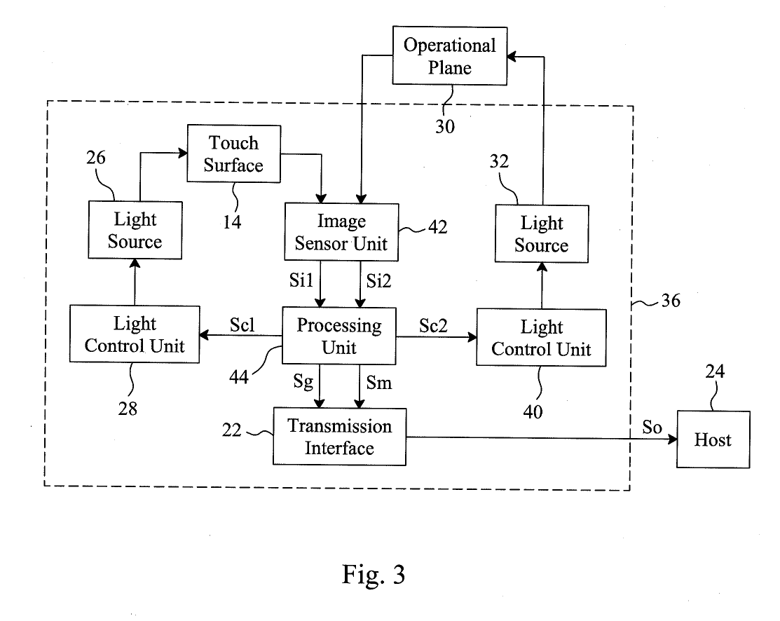

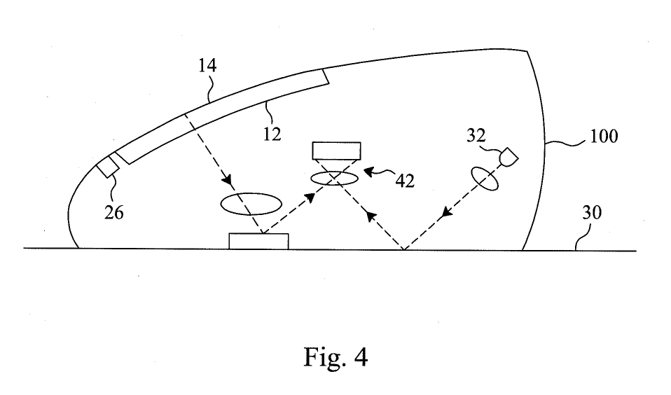

FIG. 3 is a system block diagram of a second embodiment according to the present invention, in which an optical touch device 36 also integrates gesture detection with a mouse function, while the difference from the embodiment shown in FIG. 1 is that this embodiment uses some common components to carry out the gesture detection and the mouse function. In the optical touch device 36, a light source 26, a light control unit 28, a touch surface 14, an image sensor unit 42 and a processing unit 44 establish a gesture detection module which operates as the embodiment shown in FIG. 1, and a light source 32, the image sensor unit 42 and the processing unit 44 establish a movement detection module which executes the mouse function as the embodiment shown in FIG. 2. As shown in FIG. 4, the optical components are properly arranged, including lens and a reflector to establish the optical paths, such that the light reflected by the touch surface 14 and the light reflected by the operational plane 30 both incident upon the image sensor unit 42. Since the optical touch device 36 uses a single image sensor unit 42 and a single processing unit 44 to accomplish the gesture detection and the movement detection, the costs can be reduced. Referring to FIG. 3 and FIG. 4, the processing unit 44 provides control signals Sc1 and Sc2 for the light control units 28 and 40 to control the light sources 26 and 32, respectively, for example, turning on and off the light sources 26 and 32 or adjusting light intensity of the light sources 26 and 32. Preferably, the light sources 26 and 32 are controlled to provide light alternately in a time sequence, such that when the light source 26 emits light, the image sensor unit 42 captures images by receiving light from the touch surface 14 for generating an input signal Si1, and when the light source 32 emits light, the image sensor unit 42 captures images by receiving light from the operational plane 30 for generating an input signal Si2. The processing unit 44 processes the input signals Si1 and Si2 separately, thereby generating a gesture signal Sg and a movement signal Sm for a transmission interface 22 to convert into an output signal So to sent to a host 24 that executes a command corresponding to the gesture signal Sg and controls a cursor according to the movement signal Sm. Preferably, the processing unit 44 may identify brightness of one or more images from the input signals Sit and Si2 to adjust light intensity of the light sources 26 and 32 for optimizing the clarity of the captured images, respectively.

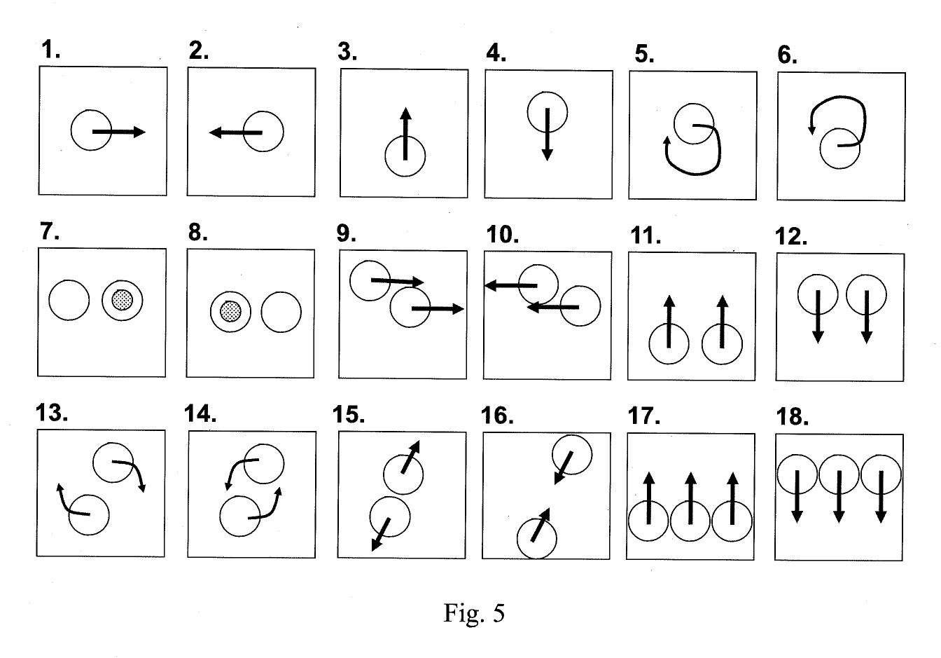

There have been many arts developed for gesture detection and relevant command execution. In addition to those commands for typical mouse operation, such as single click, double click, drag and scroll, there are popular commands such as zoom-in, zoom-out, rotate clockwise, rotate Anticlockwise, flip-up and flip-down, and more gesture-triggered commands may be found from related arts. In an embodiment, referring to the images shown in FIG. 5, various gestures can be predefined and then identified by detecting the number and the absolute movement or relative movement of fingers (i.e. light spots in the images), with corresponding commands listed in Table 1 in the following:

TABLE 1

| Item No. | Finger No. | Gesture Type | Command |
|---|---|---|---|
| 1 | 1 | Move to Right | Move to Right |
| 2 | 1 | Move to Left | Move to Left |
| 3 | 1 | Move Up | Move Up |
| 4 | 1 | Move Down | Move Down |
| 5 | 1 | Rotate Clockwise | Rotate Clockwise |
| 6 | 1 | Rotate Anticlockwise | Rotate Anticlockwise |
| 7 | 1→2 | Press & Tape | Right Click |
| 8 | 1→2 | Press & Tape | Left Click |
| 9 | 2 | Move to Right | Flip to Right |
| 10 | 2 | Move to Left | Flip to Left |
| 11 | 2 | Move Up | Flip Up |
| 12 | 2 | Move Down | Flip Down |
| 13 | 2 | Rotate Clockwise | Rotate Clockwise |
| 14 | 2 | Rotate Anticlockwise | Rotate Anticlockwise |
| 15 | 2 | Out to In | Zoom In |
| 16 | 2 | In to Out | Zoom Out |
| 17 | 3 | Move Up | Scroll Up |
| 18 | 3 | Move Down | Scroll Down |

In different embodiments, the displacement and/or the moving speed of one or more fingers may be taken into consideration for gesture definition and identification. In other embodiments, gesture definition and corresponding commands may be user defined through the operating system or relevant software running on the host 24, to optimize the operation.

In the optical touch devices 10 and 36, the touch surface 14 is on a stiff plate such as a glass plate so is highly durable. The touch point on the touch surface 14 is imaged through optical sensing and thus, not only the image can be obtained instantly, but also the location resolution depends on the resolution of the image sensor unit 16 or 42, which is much higher than the existing resistive touch panels and capacitive touch pads and touch panels. Moreover, the light sources 26 and 32 may be realized by LEDs to reduce power consumption.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An optical touch device comprising:
a touch surface configured to receive gesture operation thereon;
a light source optically coupled to the touch surface, operative to provide light to project to the touch surface;
an image sensor unit optically coupled to the touch surface, operative to capture images by receiving light from the touch surface and generate an input signal carrying the images; and
a processing unit electrically coupled to the image sensor unit, operative to receive the input signal, identify the images carried by the input signal to detect if any gesture operates on the touch surface, and generate a gesture signal if a predefined gesture is detected.

2. The optical touch device of claim 1, wherein the touch surface is on an upper surface of a light guide plate.

3. The optical touch device of claim 2, wherein the light guide plate is mounted on a housing of a mouse.

4. The optical touch device of claim 3, further comprising a movement detection module mounted at a bottom of the housing, operative to detect movement of the optical touch device for generating a movement signal.

5. The optical touch device of claim 1, further comprising a light control unit electrically coupled to the light source, operative to control the light source for light emission thereof.

6. The optical touch device of claim 5, wherein the light control unit and the processing unit are configured such that the processing unit provides a control signal for the light control unit to control the light source.

7. The optical touch device of claim 6, wherein the processing unit is configured to determine the control signal according to brightness of one or more of the images carried by the input signal for adjusting light intensity of the light source.

8. The optical touch device of claim 6, wherein the control signal controls the light source to be blinking such that the image sensor unit captures the images when the light source is on and off, respectively.

9. The optical touch device of claim 1, wherein the processing unit is configured to detect change of a finger number or a moving direction of one or more fingers by monitoring variation of the images carried by the input signal, to detect if any gesture operates on the touch surface.

10. The optical touch device of claim 1, wherein the image sensor unit is configured to generate the images in a unit of frame such that the input signal comprises frames of image contents in a time sequence.

11. The optical touch device of claim 10, wherein the processing unit is configured to compare the image contents in two or more successive frames for monitoring variation of the images carried by the input signal, to detect change of a finger number or a moving direction of one or more fingers, to further detect if any gesture operates on the touch surface accordingly.

12. The optical touch device of claim 1, further comprising:
a movement detection module configured to detect movement of the optical touch device for generating a movement signal; and
a transmission interface electrically coupled to the processing unit and the movement detection module, operative to convert the gesture signal and the movement signal into an output signal.

13. An input detection method comprising:
A.) providing light to project to a touch surface;
B.) capturing images by receiving light from the touch surface and generating an input signal carrying the images;
C.) identifying the images carried by the input signal for detecting if any gesture operates on the touch surface; and
D.) generating a gesture signal if a predefined gesture is detected.

14. The method of claim 13, wherein the step A comprises blinking the light to project to the touch surface such that the step B captures the images when the light is on and off, respectively.

15. The method of claim 13, further comprising adjusting light intensity of the light to project to the touch surface according to brightness of one or more of the images carried by the input signal.

16. The method of claim 13, wherein the step B comprises arranging the images in a unit of frame such that the input signal comprises frames of image contents in a time sequence.

17. The method of claim 16, wherein the step C comprises comparing the image contents in two or more successive frames for monitoring variation of the images carried by the input signal, to detect change of a finger number or a moving direction of one or more fingers, to further detect if any gesture operates on the touch surface accordingly.

18. The method of claim 13, wherein the step C comprises detecting change of a finger number or a moving direction of one or more fingers by monitoring variation of the images carried by the input signal, to detect if any gesture operates on the touch surface.

19. The method of claim 13, further comprising detecting movement of the optical touch device for generating a movement signal.

20. An optical touch device comprising:
a touch surface configured to receive gesture operation thereon;
a first light source optically coupled to the touch surface, operative to provide first light to project to the touch surface;
a second light source optically coupled to an operational plane having the optical touch device thereon, operative to provide second light to project to the operational plane;
an image sensor unit optically coupled to the touch surface and the operational plane, respectively, operative to capture first images by receiving the first light reflected from the touch surface and generate a first input signal carrying the first images, and to capture second images by receiving the second light reflected from the operational plane and generate a second input signal carrying the second images; and
a processing unit electrically coupled to the image sensor unit, operative to receive the first input signal and the second input signal, identify the first images carried by the first input signal to detect if any gesture operates on the touch surface, generate a gesture signal if a predefined gesture is detected, identify the second images carried by the second input signal to detect movement of the optical touch device, and generate a movement signal according to the detected movement of the optical touch device.

21. The optical touch device of claim 20, wherein the touch surface is on an upper surface of a light guide plate.

22. The optical touch device of claim 21, wherein the light guide plate is mounted on a housing of a mouse.

23. The optical touch device of claim 20, further comprising a light control unit electrically coupled to the first light source, operative to control the first light source for light emission thereof.

24. The optical touch device of claim 23, wherein the light control unit and the processing unit are configured such that the processing unit provides a control signal for the light control unit to control the first light source.

25. The optical touch device of claim 24, wherein the processing unit is configured to determine the control signal according to brightness of one or more of the first images carried by the first input signal for adjusting light intensity of the first light source.

26. The optical touch device of claim 20, further comprising a light control unit electrically coupled to the second light source, operative to control the second light source for light emission thereof.

27. The optical touch device of claim 26, wherein the light control unit and the processing unit are configured such that the processing unit provides a control signal for the light control unit to control the second light source.

28. The optical touch device of claim 27, wherein the processing unit is configured to determine the control signal according to brightness of one or more of the second images carried by the second input signal for adjusting light intensity of the second light source.

29. The optical touch device of claim 20, wherein the control signal controls the first light source to be blinking such that the image sensor unit captures the first images when the first light source is on and off, respectively.

30. The optical touch device of claim 20, wherein the first and second light sources are switched on and off alternately in a time sequence.

31. The optical touch device of claim 20, wherein the processing unit is configured to detect change of a finger number or a moving direction of one or more fingers by monitoring variation of the first images carried by the first input signal, to detect if any gesture operates on the touch surface.

32. The optical touch device of claim 20, wherein the image sensor unit is configured to generate the first images in a unit of frame such that the first input signal comprises frames of first image contents in a time sequence.

33. The optical touch device of claim 32, wherein the processing unit is configured to compare the first image contents in two or more successive frames for monitoring variation of the first images carried by the first input signal, to detect change of a finger number or a moving direction of one or more fingers, to further detect if any gesture operates on the touch surface accordingly.

34. An input detection method for an optical touch device having a touch surface to receive gesture operation thereon, the method comprising:
A.) providing first light to project to the touch surface;
B.) capturing first images by receiving the first light reflected from the touch surface and generating a first input signal carrying the first images;
C.) identifying the first images carried by the input signal for detecting if any gesture operates on the touch surface;
D.) generating a gesture signal if a predefined gesture is detected;
E.) providing second light to project to an operational plane having the optical touch device thereon;
F.) capturing second images by receiving the second light reflected from the operational plane for generating a second input signal;
G.) identifying the second images carried by the second input signal for detecting movement of the optical touch device; and
H.) generating a movement signal according to the detected movement of the optical touch device.

35. The method of claim 34, wherein the step A comprises blinking the first light such that the step B captures the first images when the first light is on and off, respectively.

36. The method of claim 34, further comprising adjusting light intensity of the first light according to brightness of one or more of the first images carried by the first input signal.

37. The method of claim 34, wherein the step B comprises arranging the first images in a unit of frame such that the first input signal comprises frames of first image contents in a time sequence.

38. The method of claim 37, wherein the step C comprises comparing the first image contents in two or more successive frames for monitoring variation of the first images carried by the first input signal, to detect change of a finger number or a moving direction of one or more fingers, to further detect if any gesture operates on the touch surface accordingly.

39. The method of claim 34, wherein the step C comprises detecting change of a finger number or a moving direction of one or more fingers by monitoring variation of the first images carried by the first input signal, to detect if any gesture operates on the touch surface.

40. The method of claim 34, further comprising adjusting light intensity of the second light according to brightness of one or more of the second images carried by the second input signal.

41. The method of claim 34, wherein the first and second images are captured alternately in a time sequence.
